(19) United States
(12) Patent Application Publication
(10) Pub. No.: US 2017/0177128 A1
(43) Pub. Date: Jun. 22, 2017

(54) DISPLAY DEVICE

(71) Applicant: SAMSUNG DISPLAY CO., LTD., Yongin-si (KR)

(72) Inventor: Sunkwun SON, Suwon-si (KR)

(21) Appl. No.: 15/220,477

(22) Filed: Jul. 27, 2016

(30) Foreign Application Priority Data
Dec. 18, 2015 (KR) 10-2015-0181657

(51) Int. Cl. G06F 3/041

(52) U.S. Cl. CPC G06F 3/0412; G06F 2203/04107

(57) ABSTRACT

A display device includes: a first substrate on which a display area and a non-display area are defined; a second substrate opposing the first substrate; and an insulating layer on the second substrate in the non-display area, where a height of the insulating layer decreases toward the display area, and an end portion of the insulating layer, which is adjacent to the display area, has a taper angle in a range of about 20 degrees to about 35 degrees.

This application claims priority to Korean Patent Application No. 10-2015-0181657, filed on Dec. 18, 2015, and all the benefits accruing therefrom under 35 U.S.C. §119, the content of which in its entirety is herein incorporated by reference.

### BACKGROUND

1. Field

Exemplary embodiments of the invention relate to a display device, and more particularly, to a display device including a touch sensor.

2. Description of the Related Art

A flat panel display (“FPD”) device, e.g., an organic light emitting diode (“OLED”) display device, a liquid crystal display (“LCD”) device, an electrophoretic display (“EPD”) device and the like, typically includes a display panel which includes a field generating electrode and an electro-optical active layer. As the electro-optical active layers, display panels of the OLED display device, the LCD device and the EPD device include an organic light emitting layer, a liquid crystal layer and charged particles, respectively. The field generating electrode is connected to a switching element, e.g., a thin film transistor, to receive a data signal. The electro-optical active layer converts the data signal into an optical signal to display an image.

Recently, such display devices may include a touch sensing function which enables user interaction, in addition to an image display function using display panels. The touch sensing function detects changes in, e.g., pressure, charge or light applied to a display screen, in response to a touch input being applied to the display screen by a finger or a touch pen, and generates touch information indicating, for example, whether the display screen is touched, or the touched position. The display device may receive an image signal based on the touch information.

The touch sensing function may be performed by a touch sensor including a touch electrode. As the size of the display panel increases, the number of channels in the touch sensor increases, such that the number of touch signal lines configured to transmit signals to, or receive signals from, the touch electrode may be increased. In general, the touch signal line is designed to be disposed in a peripheral area, which is a non-display area of the display panel, and an insulating layer is disposed to cover and protect the touch signal line. In addition, a polarizer is typically disposed on the insulating layer and the touch sensor, such that the polarizer may be detached from the insulating layer, or stains may be formed between the polarizer and the insulating layer.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the invention are directed to a display device which prevents stain formation between an insulating layer and a polarizer and detachment of the polarizer from the insulating layer.

According to an exemplary embodiment of the invention, a display device includes: a first substrate on which a display area and a non-display area are defined; a second substrate opposing the first substrate; and an insulating layer on the second substrate in the non-display area, where a height of the insulating layer decreases toward the display area, and an end portion of the insulating layer, which is adjacent to the display area, has a taper angle in a range of about 20 degrees to about 35 degrees.

In an exemplary embodiment, the end portion of the insulating layer may include an uneven portion.

In an exemplary embodiment, a height of the uneven portion may decrease toward the display area.

In an exemplary embodiment, the uneven portion may extend along an edge of the display area.

In an exemplary embodiment, an overall width of the uneven portion may be in a range of about 0.01 millimeters to about 0.2 millimeters.

In an exemplary embodiment, the uneven portion may be spaced apart from an edge of the display area.

In an exemplary embodiment, a distance between the uneven portion and the edge of the display area may be in a range of about 0.3 millimeters to about 0.9 millimeters.

In an exemplary embodiment, the display device may further include a polarizer on the second substrate.

In an exemplary embodiment, the insulating layer may include a base portion, and the uneven portion extends from the base portion.

In an exemplary embodiment, the polarizer may cover the uneven portion and a portion of the base portion, which is connected to the uneven portion.

In an exemplary embodiment, a width of an overlapping area between the polarizer and the portion of the base portion may be in a range of about 0.5 millimeters to about 1.1 millimeters.

In an exemplary embodiment, the display device may further include a window on the polarizer.

In an exemplary embodiment, the display device may further include an adhesive layer between the window and the polarizer.

In an exemplary embodiment, the display device may further include: a touch electrode on the second substrate; and a touch signal line connected to the touch electrode to transmit a touch signal to, or receive a touch signal from, the touch electrode.

In an exemplary embodiment, the insulating layer may cover the touch signal line.

In an exemplary embodiment, the touch electrodes may include a plurality of first touch electrodes and a plurality of second touch electrodes, and one of the first touch electrodes and the second touch electrodes may be a sensing input electrode, and the other of the first touch electrodes and the second touch electrodes may be a sensing output electrode.

In an exemplary embodiment, the touch signal lines may include a first touch signal line connected to the first touch electrode and a second touch signal line connected to the second touch electrode.

According to another exemplary embodiment of the invention, a display device includes: a first substrate, on which a display area and a non-display area are defined; a second substrate opposing the first substrate; and an insulating layer on the second substrate in the non-display area, where the insulating layer has an uneven portion, and a height of the uneven portion decreases toward the display area.

In an exemplary embodiment, the uneven portion may extend along an edge of the display area.

In an exemplary embodiment, an overall width of the uneven portion may be in a range of about 0.01 millimeters to about 0.2 millimeters.

### BRIEF DESCRIPTION OF THE DRAWINGS

The above and other features and exemplary embodiments of the invention of invention will be more clearly understood from the following detailed description taken in conjunction with the accompanying drawings, in which:

FIG. 1 is a schematic block diagram illustrating an exemplary embodiment of a display device;

FIG. 2 is a top plan view illustrating an exemplary embodiment of a touch sensor of the display device of FIG. 1;

FIG. 3 is a top plan view illustrating an exemplary embodiment of an insulating layer of the display device of FIG. 1;

FIG. 4 is a cross-sectional view taken along line I-I′ of FIG. 3;

FIG. 5 is an enlarged top plan view of area “A” of FIG. 3;

FIG. 6 is a schematic top plan view illustrating an alternative exemplary embodiment of an insulating layer of a display device;

FIG. 7 is a cross-sectional view taken along line II-II′ of FIG. 6;

FIG. 8 is an enlarged top plan view of area “B” of FIGS. 6; and

FIG. 9 is a schematic cross-sectional view illustrating another alternative exemplary embodiment of an insulating layer of a display device.

### DETAILED DESCRIPTION

Advantages and features of the invention and methods for achieving them will be made clear from exemplary embodiments described below in detail with reference to the accompanying drawings. The invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. The invention is merely defined by the scope of the claims. Therefore, well-known constituent elements, operations and techniques are not described in detail in the exemplary embodiments in order to prevent the invention from being obscurely interpreted. Like reference numerals refer to like elements throughout the specification.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the invention will be described in detail with reference to the accompanying drawings.

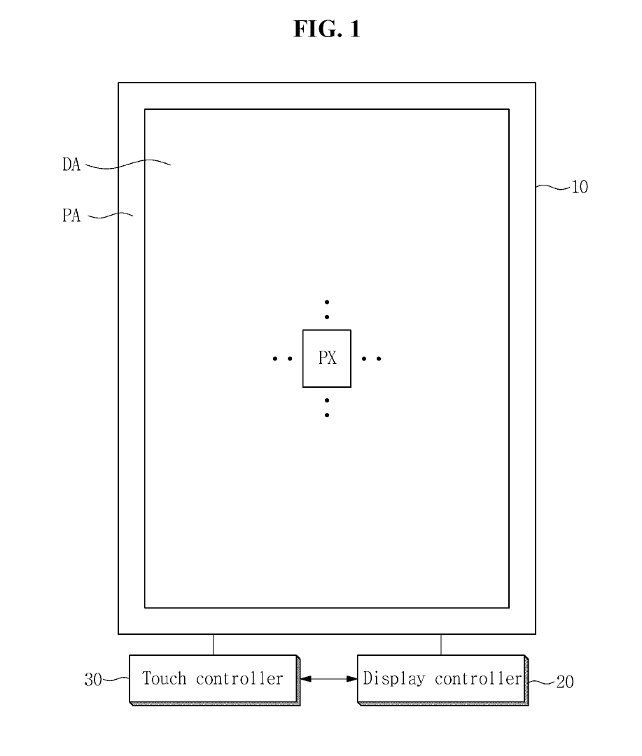

An exemplary embodiment of a display device will now be described with reference to FIGS. 1, 2, 3, 4, and 5.

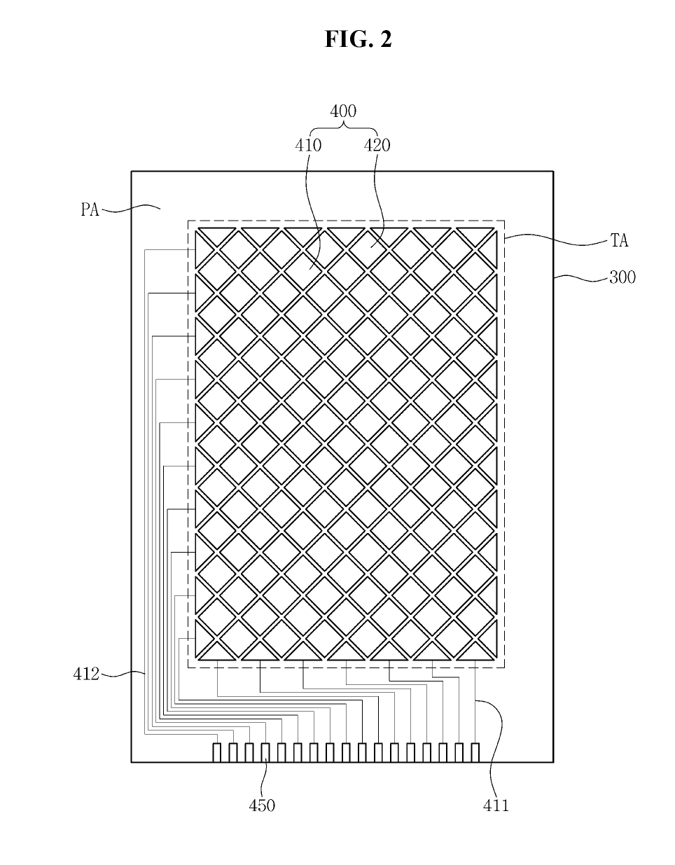

FIG. 1 is a schematic block diagram illustrating an exemplary embodiment of a display device. FIG. 2 is a top plan view illustrating an exemplary embodiment of a touch sensor of the display device of FIG. 1.

Referring to FIG. 1, an exemplary embodiment of the display device includes a display panel 10, a display controller 20 connected to the display panel 10, and a touch controller 30 connected to the display panel 10.

In an exemplary embodiment, the display panel 10 is configured to display an image and detect a touch input. The display panel 10 includes a display area DA in which an image is displayed and a peripheral area PA surrounding the display area DA.

A portion, or the entirety, of the display panel 10 may be a touch active area TA capable of detecting a touch input, e.g., a position or intensity of a touch thereon. The touch active area TA is an area capable of detecting a touch input in a case in which an actual object approaches or contacts the display panel 10. In such an embodiment, the touch input may be generated when an external object, e.g., a finger of a user, is in direct contact with the display panel 10 or when an external object approaches or hovers over the display panel 10.

In an exemplary embodiment, as illustrated in FIG. 2, the display area DA and the touch active area TA may coincide with one another, but not being limited thereto. In one exemplary embodiment, for example, the touch active area TA may overlap the entirety of the display area DA and a portion of the peripheral area PA. Alternatively, the touch active area TA may overlap only a portion of the display area DA.

Referring to FIG. 2, a touch electrode layer 400 is disposed on a second substrate 300. The touch electrode layer 400 is disposed in the touch active area TA in which a touch input is detected.

The touch electrode layer 400 may detect a touch input in various manners. The touch electrode layer 400 may include a touch sensor. In an exemplary embodiment, the touch sensor may be classified into resistive-type, capacitive-type, electro-magnetic-type, and optical-type touch sensors. In an exemplary embodiment, where the touch sensor is the capacitive-type touch sensor will be described.

The touch electrode layer 400 includes a plurality of touch electrodes. The plurality of touch electrodes includes a plurality of first touch electrodes 410 and a plurality of second touch electrodes 420. The first touch electrode 410 and the second touch electrode 420 are physically and electrically separated from one another.

The plurality of first and second touch electrodes 410 and 420 may be alternately arranged and spaced apart from each other such that the first and second touch electrodes 410 and 420 do not substantially overlap one another in the touch active area TA. The plurality of first touch electrodes 410 may be arranged in each column and each row, and the plurality of second touch electrodes 420 may be arranged in each column and each row.

The first touch electrode 410 and the second touch electrode 420 are disposed in substantially the same layer, or may be disposed in different layers. In an exemplary embodiment, each of the first touch electrode 410 and the second touch electrode 420 may have substantially a rectangular shape, but not being limited thereto. In an alternative exemplary embodiment, the first touch electrode 410 and the second touch electrode 420 may have any suitable shape, e.g., may include a protrusion, to enhance sensitivity of the touch electrode layer 400.

In an exemplary embodiment, the plurality of first touch electrodes 410 in the same row or column may be connected to, or separated from, one another inside or outside the touch active area TA. In such an embodiment, the plurality of second touch electrodes 420 in the same row or column may be connected to, or separated from, one another inside or outside the touch active area TA. In an exemplary embodiment, the plurality of first touch electrodes 410 in the same column is connected to one another inside the touch active area TA, and the plurality of second touch electrodes 420 in the same row may be connected to one another inside the touch active area TA.

In such an embodiment, as shown in FIG. 2, the first touch electrodes 410 connected to one another in each column are connected to the touch controller 30 through a first touch signal line 411, and the second touch electrodes 420 connected to one another in each row are connected to the touch controller 30 through a second touch signal line 412. In an exemplary embodiment, as illustrated in FIG. 2, the first touch signal line 411 and the second touch signal line 412 may be disposed on the second substrate 300 and in the peripheral area PA. Respective end portions of the first touch signal lines 411 and the second touch signal lines 412 may define pad portions 450, or connected to the pad portions 450, in the peripheral area PA of the second substrate 300.

The first touch electrode 410 and the second touch electrode 420 have a predetermined transmittance or higher so that light from a display layer 200 is transmitted therethrough. In one exemplary embodiment, for example, the first touch electrode 410 and the second touch electrode 420 may include a transparent conductive material, e.g., indium-tin oxide (“ITO”), indium-zinc oxide (“IZO”), a thin metal layer, e.g., a silver nanowire (AgNw), metal mesh, or a carbon nanotube (“CNT”).

The first touch signal line 411 and the second touch signal line 412 may include a metal, e.g., molybdenum (Mo), silver (Ag), titanium (Ti), copper (Cu), aluminum (Al), or molybdenum/aluminum/molybdenum (Mo/Al/Mo). In an exemplary embodiment, the first touch signal line 411 and the second touch signal line 412 may include a transparent conductive material included in the first touch electrode 410 and the second touch electrode 420.

One of the first touch electrodes 410 and one of the second touch electrodes 420, which are adjacent to each other, collectively define a mutual sensing capacitor to serve as a touch sensor. The mutual sensing capacitor may serve as a sensing input electrode to receive a sensing input signal through one of the first and second touch electrodes 410 and 420, and may serve as a sensing output electrode to output a change in stored charge caused by a touch input from an external object as a sensing output signal through the other of the first and second touch electrodes 410 and 420. As used herein, the terms “sensing input signal” and “sensing output signal” are collectively referred to as a touch signal.

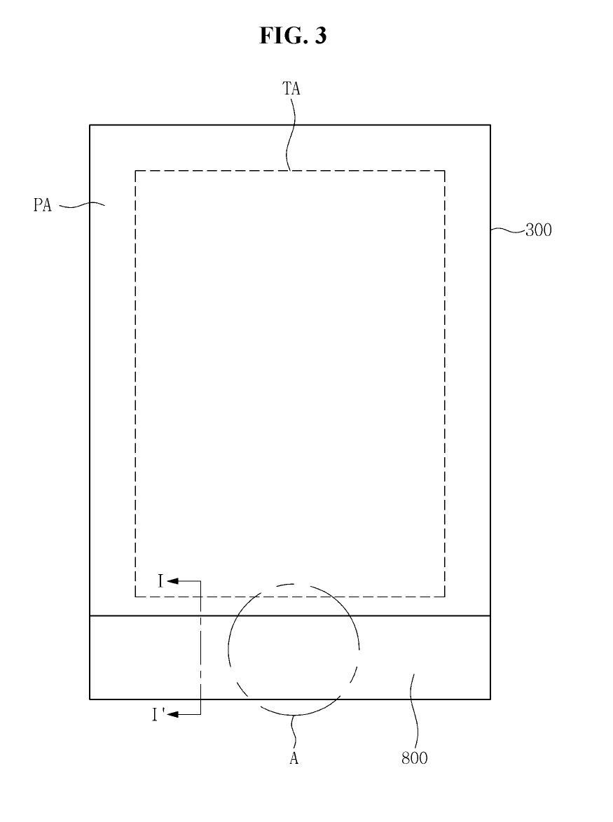

Hereinafter, a structure of an exemplary embodiment of the display device including an insulating layer 800 will be described in detail with reference to FIGS. 3, 4, and 5.

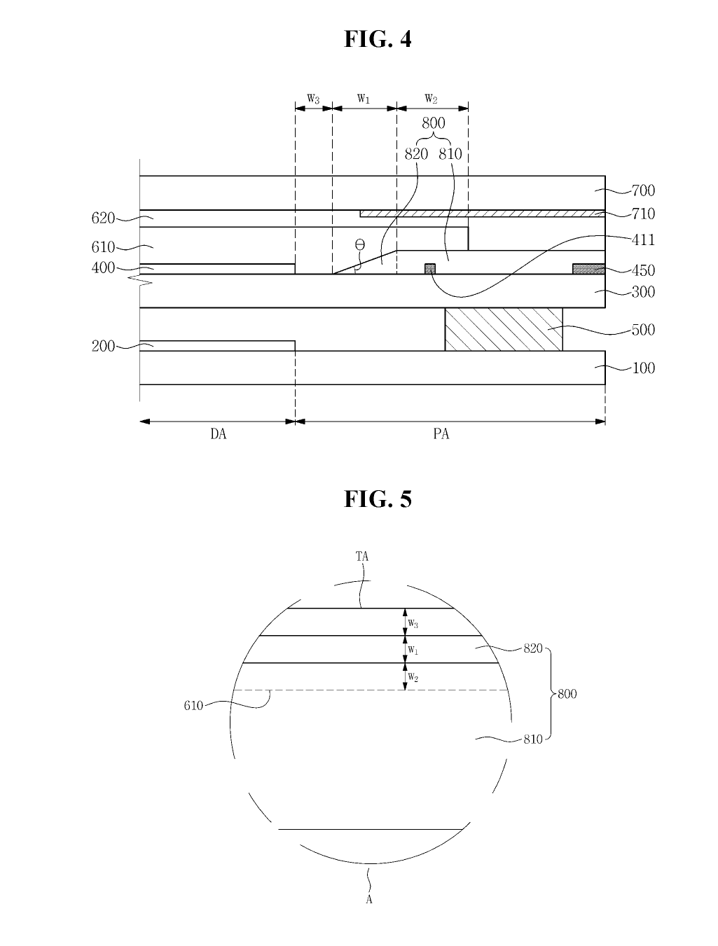

FIG. 3 is a schematic top plan view illustrating an exemplary embodiment of the insulating layer 800 of the display device of FIG. 1. FIG. 4 is a cross-sectional view taken along line I-I′ of FIG. 3. FIG. 5 is an enlarged top plan view of area “A” of FIG. 3.

Referring to FIGS. 3, 4, and 5, an exemplary embodiment of the display panel 10 includes a first substrate 100 and the second substrate 300 opposing one another, the display layer 200 on the first substrate 100, and the touch electrode layer 400 on the second substrate 300, the touch electrode layer 400 that provides a touch sensor. The first substrate 100 and the second substrate 300 may be sealed by a sealant 500 in the peripheral area PA.

The display layer 200 including an electro-optical active layer is disposed on the first substrate 100 including a transparent insulator, e.g., a glass substrate. The display layer 200 includes a plurality of pixels and a plurality of display signal lines (not illustrated) connected to the pixels to transmit driving signals. The display layer 200 is typically disposed in the display area DA.

The display signal line includes a plurality of gate lines (not illustrated) to transmit gate signals, and a plurality of data lines (not illustrated) to transmit data signals. The gate lines and the data lines may extend to cross one another. The display signal line may extend toward the peripheral area PA to be connected to a display pad portion (not illustrated) defined in the peripheral area PA.

The plurality of pixels may be arranged substantially in a matrix form, but are not limited thereto. Each of the pixels may include a switching element (not illustrated) connected to the gate line and the data line, and a pixel electrode (not illustrated) connected to the switching element.

The switching element may be a three-terminal element, e.g., a thin film transistor integrated in the display panel 10. The switching element may be turned on or off based on the gate signal applied from the gate line, and may selectively apply the data signal applied from the data line to the pixel electrode. In such an embodiment, the pixel may further include a common electrode (not illustrated) opposing the pixel electrode. In an exemplary embodiment where the display device is a LCD device, for example, a liquid crystal layer (not illustrated) may be disposed between the pixel electrode and the common electrode. The common electrode may receive a common voltage.

To provide a color display, each of the pixels may display one of primary colors. A desired color may be achieved by mixing the primary colors. The primary colors may include three primary colors, e.g., red, green, and blue, or four primary colors. The pixels are disposed corresponding to the pixel electrodes, respectively. Each of the pixels may further include a color filter (not illustrated) which displays one of the primary colors.

The touch electrode layer 400, including a transparent insulator, e.g., glass, on the second substrate 300 may include the plurality of first and second touch electrodes 410 and 420. The touch electrode layer 400 may be disposed in the touch active area TA.

The sealant 500 may be disposed in the peripheral area PA between the first substrate 100 and the second substrate 300 opposing one another. The sealant 500 may have a closed line shape that surrounds the display area DA along edge portions of the peripheral area PA when viewed in a top plan view. In such an embodiment, the sealant 500 couples the first substrate 100 and the second substrate 300 to one another, and effectively prevents contaminants, e.g., moisture and/or oxygen, from infiltrating between the first substrate 100 and the second substrate 300. A reflective layer (not illustrated) may be disposed between the first substrate 100 and the sealant 500 to enhance operational efficiency of laser irradiated during the formation of the sealant 500. The reflective layer and the sealant 500 may have the same planar shape when viewed in the top plan view.

In an exemplary embodiment, where the display device is an OLED display device, the second substrate 300 may serve as an encapsulation substrate. In such an example, the second substrate 300 may effectively prevent contaminants, e.g., moisture and/or oxygen, from infiltrating thereinto.

The first and second touch signal lines 411 and 412, including a metal, transmit signals to and/or receive signals from the first and second touch electrodes 410 and 420 of the touch electrode layer 400. The first and second touch signal lines 411 and 412 are disposed on the second substrate 300 and in the peripheral area PA.

In an exemplary embodiment, as shown in FIGS. 3 and 4, the insulating layer 800 is disposed on the second substrate 300 and in the peripheral area PA.

In such an embodiment, the insulating layer 800 covers and protects the first and second touch signal lines 411 and 412. The insulating layer 800 may include an organic material. In an exemplary embodiment, as shown in FIG. 3, the insulating layer 800 is disposed on one side of the four sides of the peripheral area PA, but not being limited thereto. In an alternative exemplary embodiment, the insulating layer 800 may be disposed on two or more sides of the four sides of the peripheral area PA.

A portion of the insulating layer 800 may be covered by a polarizer 610 which will be described in detail below. The polarizer 610 is disposed corresponding to the display area DA, and due to potential process errors, may cover a portion of the insulating layer 800. Accordingly, in a conventional display device, when an insulating layer is steeply inclined at a portion thereof that contacts a polarizer, the polarizer may not be completely attached to the insulating layer but slightly detached therefrom. Thus, a gap is generated between the polarizer and the insulating layer. When contaminants, e.g., air and/or moisture, infiltrate into the gap between the polarizer and the insulating layer, the polarizer or the insulating layer may be deformed.

The deformed portion of the polarizer or the insulating layer may appear as stains.

In an exemplary embodiment, a height of the insulating layer 800 decreases toward the display area DA to effectively prevent the gap between the polarizer and the insulating layer from being generated. In one exemplary embodiment, for example, an end portion of the insulating layer 800, which adjacent to the display area DA, has a taper angle θ in a range of about 20 degrees to about 35 degrees. As the insulating layer 800 has a gradual inclination at a portion thereof that contacts the polarizer 610, defective contact and stain formation between the polarizer 610 and the insulating layer 800 may be substantially reduced or effectively prevented.

Hereinafter, the configuration of an exemplary embodiment of the insulating layer 800 will be described in detail with reference to FIG. 5 which illustrates the enlarged top plan view of area “A” of FIG. 3. For ease of description, the insulating layer 800 will be described as being divided into a base portion 810 and an inclined portion 820, which may correspond to the end portion having the taper angle θ. In an exemplary embodiment, a width w1 of the inclined portion 820 of the insulating layer 800 is in a range of about 0.01 millimeters to about 0.2 millimeters. In an exemplary embodiment, a width w2 of an overlapping area between the polarizer 610 and a portion of an upper surface of the base portion 810 of the insulating layer 800 is in a range of about 0.5 millimeters to about 1.1 millimeters. In an exemplary embodiment, a distance w3 between the insulating layer 800 and an edge of the display area DA is in a range of about 0.3 millimeters to about 0.9 millimeters.

The polarizer 610 for reducing reflection of ambient light may be disposed on the touch electrode layer 400. The polarizer 610 may include a linear polarizer, a phase retardation plate, and the like.

A window 700 including, e.g., glass, is disposed on the polarizer 610 to protect elements therebelow, e.g., the first substrate 100, the display layer 200, the second substrate 300, the touch electrode layer 400 and the like. A light blocking layer 710 may be disposed on an edge of a surface of the window 700 that is opposite to the second substrate 300. The light blocking layer 710 may be disposed to cover at least a portion of the peripheral area PA of the display panel 10. The window 700 may be attached to the polarizer 610 through an adhesive layer 620 including an adhesive material, e.g., a resin.

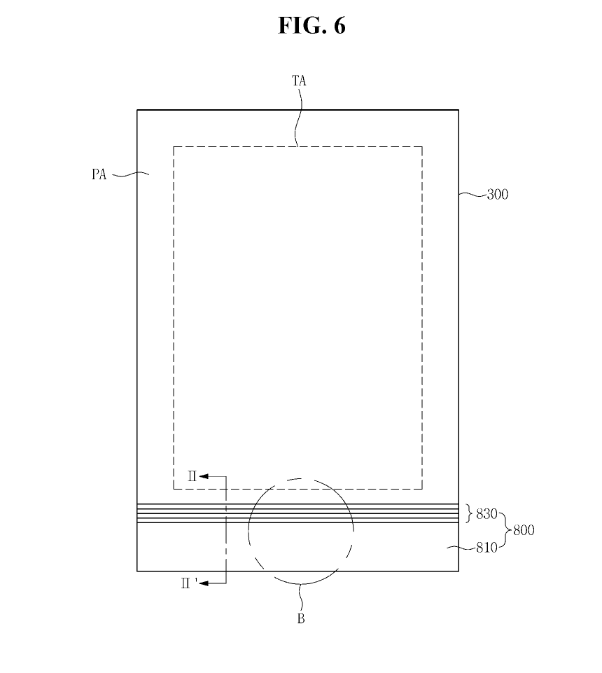

Hereinafter, alternative exemplary embodiments will be described with reference to FIGS. 6, 7, 8, and 9. For convenience and conciseness of description, the elements of a display device that are the same as those described above with reference to FIGS. 1 to 5 will be omitted.

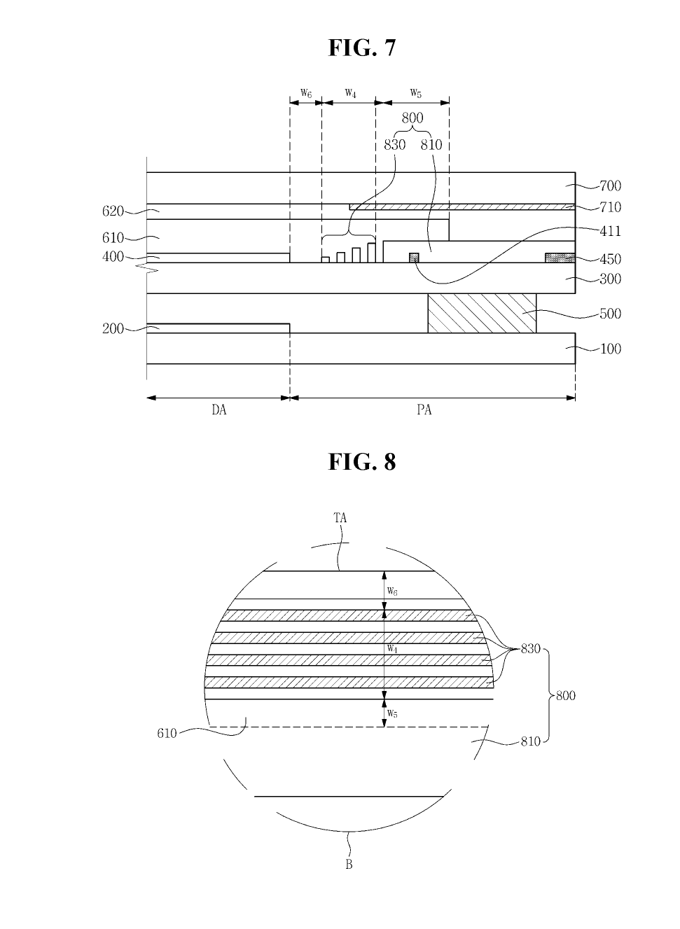

FIG. 6 is a schematic top plan view illustrating an alternative exemplary embodiment of an insulating layer 800 of a display device. FIG. 7 is a cross-sectional view taken along line II-II′ of FIG. 6. FIG. 8 is an enlarged top plan view of area “B” of FIG. 6.

Referring to FIGS. 6, 7 and 8, an exemplary embodiment of the insulating layer 800 may have an uneven portion 830 in a manner dissimilar to that described in the previous exemplary embodiment. A height of the uneven portion 830 decreases toward the display area DA. The uneven portion 830 extends along an edge of the display area DA. As illustrated in FIG. 7, in an exemplary embodiment, the uneven portion 830 may include protruded portions, and each of the protruding portions may have, for example, a bar shape when viewed in a top plan view. In such an embodiment, the uneven portion 830 may have a slit pattern when viewed in a top plan view. In such an embodiment, the protruded portions may have heights difference from each other. Respective heights of the protruded portions gradually decrease toward the display area DA. In an alternative exemplary embodiment, the plurality of protruded portions may be disposed in an island pattern, thereby being arranged as respective islands. Respective heights of the island-shaped protruded portions gradually decrease toward the display area DA.

The uneven portion 830 may be spaced apart from an edge of the display area DA. In such an embodiment, due to the uneven portion 830 of the insulating layer 800, adhesion between the polarizer 610 and the insulating layer 800 may be increased, and stain formation therebetween may be substantially reduced or effectively prevented.

Hereinafter, the configuration of the insulating layer 800 will be described in detail with reference to FIG. 8 which illustrates the enlarged top plan view of area “B” of FIG. 6. For ease of description, the insulating layer 800 will be described as being divided into the base portion 810 and the uneven portion 830. An overall width w4 of the uneven portion 830 of the insulating layer 800 is in a range of about 0.01 millimeters to about 0.2 millimeters. A width w5 of an overlapping area between the polarizer 610 and a portion of an upper surface of the base portion 810 of the insulating layer 800 is in a range of about 0.5 millimeters to about 1.1 millimeters. A distance w6 between the uneven portion 830 and an edge of the display area DA is in a range of about 0.3 millimeters to about 0.9 millimeters.

In one exemplary embodiment, for example, a half-tone mask (not illustrated) may be used to provide the insulating layer 800 having the uneven portion 830. The half-tone mask may have a slit pattern corresponding to an area for providing the uneven portion 830. The slit pattern may include a plurality of slits. A width of each of the slits may be in a range of about 0.9 micrometers to about 4.0 micrometers. The plurality of slits is sequentially provided in the half-tone mask from one of the slits having the least width to one of the slits having the greatest width. The respective widths of the slits may gradually increase at a rate of about 0.1 micrometers. When the slits of the half-tone mask are provided as described hereinabove, the uneven portion 830 having a gradually decreasing height may be provided.

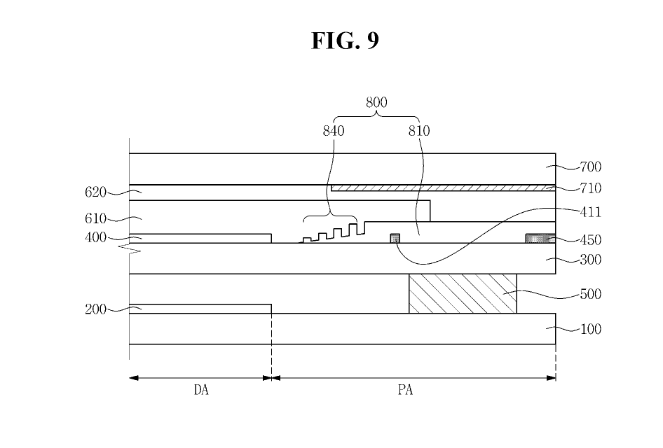

FIG. 9 is a schematic cross-sectional view illustrating another alternative exemplary embodiment of an insulating layer 800 of a display device.

Referring to FIG. 9, an exemplary embodiment of the insulating layer 800 may have an uneven portion 840 in a manner dissimilar to that described above with reference to FIGS. 6 to 8. In an exemplary embodiment, the uneven portion 840 may include a protruding portion and a recessed portion. In such an embodiment, the recessed portion is not completely removed from the uneven portion 840 in a manner dissimilar to that described in the previous exemplary embodiment. In such an embodiment, the uneven portion 840 may extend from the base portion 810. In an exemplary embodiment, where the insulating layer 800 has the uneven portion 840, adhesion between the insulating layer 800 and the polarizer 610 may be increased and stain formation therebetween may be substantially reduced or effectively prevented.

As set forth above, in exemplary embodiments of the display device, stain formation between the display area and the peripheral area at which the insulating layer and the polarizer contact one another may be substantially reduced or effectively prevented. Accordingly, the image quality of the display device may be enhanced.

In such embodiments, detachment of the polarizer from the insulating layer may be prevented.

From the foregoing, it will be appreciated that various exemplary embodiments in accordance with the invention have been described herein for purposes of illustration, and that various modifications may be made without departing from the scope and spirit of the teachings. Accordingly, the various exemplary embodiments disclosed herein are not intended to be limiting of the true scope and spirit of the teachings. Various features of the above described and other exemplary embodiments can be mixed and matched in any manner, to produce further exemplary embodiments consistent with the invention.

What is claimed is:

1. A display device comprising:
a first substrate on which a display area and a non-display area are defined;
a second substrate opposing the first substrate; and
an insulating layer on the second substrate in the non-display area,
wherein a height of the insulating layer decreases toward the display area, and
wherein an end portion of the insulating layer, which is adjacent to the display area, has a taper angle in a range of about 20 degrees to about 35 degrees.

2. The display device of claim 1, wherein the end portion of the insulating layer comprises an uneven portion.

3. The display device of claim 2, wherein a height of the uneven portion decreases toward the display area.

4. The display device of claim 2, wherein the uneven portion extends along an edge of the display area.

5. The display device of claim 2, wherein an overall width of the uneven portion is in a range of about 0.01 millimeters to about 0.2 millimeters.

6. The display device of claim 2, wherein the uneven portion is spaced apart from an edge of the display area.

7. The display device of claim 6, wherein a distance between the uneven portion and the edge of the display area is in a range of about 0.3 millimeters to about 0.9 millimeters.

8. The display device of claim 2, further comprising:
a polarizer on the second substrate.

9. The display device of claim 8, wherein
the insulating layer comprises a base portion, and
the uneven portion extends from the base portion.

10. The display device of claim 9, wherein the polarizer covers the uneven portion and a portion of the base portion, which is connected to the uneven portion.

11. The display device of claim 10, wherein a width of an overlapping area between the polarizer and the portion of the base portion is in a range of about 0.5 millimeters to about 1.1 millimeters.

12. The display device of claim 8, further comprising:
a window on the polarizer.

13. The display device of claim 12, further comprising:
an adhesive layer between the window and the polarizer.

14. The display device of claim 1, further comprising:
a touch electrode on the second substrate; and
a touch signal line connected to the touch electrode to transmit a touch signal to, or receive a touch signal from, the touch electrode.

15. The display device of claim 14, wherein the insulating layer covers the touch signal line.

16. The display device of claim 14, wherein
the touch electrodes comprises a plurality of first touch electrodes and a plurality of second touch electrodes,
one of the first touch electrodes and the second touch electrodes are a sensing input electrode, and
the other of the first touch electrodes and the second touch electrodes are a sensing output electrode.

17. The display device of claim 16, wherein the touch signal lines comprises:
a first touch signal line connected to the first touch electrode; and
a second touch signal line connected to the second touch electrode.

18. A display device, comprising:
a first substrate on which a display area and a non-display area are defined;
a second substrate opposing the first substrate; and
an insulating layer on the second substrate in the non-display area,
wherein the insulating layer comprises an uneven portion, and
a height of the uneven portion decreases toward the display area.

19. The display device of claim 18, wherein the uneven portion extends along an edge of the display area.

20. The display device of claim 18, wherein an overall width of the uneven portion is in a range of about 0.01 millimeters to about 0.2 millimeters.
